(19) United States
(12) Patent Application Publication
(10) Pub. No.: US 2003/0101069 A1
(43) Pub. Date: May 29, 2003

(54) Cargo collection and delivery system

(76) Inventor: Masayuki Sando, Tokyo (JP)

Correspondence Address: KANESAKA AND TAKEUCHI, 1423 Powhatan Street, Alexandria, VA, 22314, US

(21) Appl. No.: 10/078,545

(22) Filed: Feb. 21, 2002

(30) Foreign Application Priority Data
Nov. 29, 2001 (JP) 2001-363896

(51) Int. Cl. G06F 17/60

(52) U.S. Cl. 705/1

(57) ABSTRACT

The slip processing and assorting operations of the collected and delivered cargoes are not widely, effectively and rationally improved due to time and spatial limits, institutional limits and limits on the part of the user.

Upon receipt of a request cargo collection request from clients 2 and 2A, a control center 1 issues cargo slip information, which can be specified by a cargo unit.

A cargo agency 3 receives the cargo slip information, prints it in print letter and so on, on a slip and writes it in a non-contact tag constituted by an IC chip and it is attached to the cargo carried in by the client so that the slip processing is performed. A cargo collection and delivery truck 4 uses a portable terminal and attaches the slip, wherein the slip information is received and printed in print letter, to the cargo collected, and further writes a slip number on the non-contact tag to de the slip processing. A cargo collection/delivery center 5 instructs the cargo collection and delivery truck to collect the cargoes on the basis of the slip information, processes the slip of the cargoes collected on the basis of the non-contact tag and performs warehousing-in/warehousing-out control and assorting operations.

### FIELD OF THE INVENTION

The prevent invention relates to a cargo collection and delivery system in a physical distribution operation where the cargo is collected from a place of shipment and is delivered to a destination of shipment, and more in particular, to a system supporting a slip transaction and an assorting operation of the cargo.

### DESCRIPTION OF THE RELATED ART

Accompanied with the growth of economy and the development of society, this type of the physical distribution operation has become more complicated and has been steadily gaining a speed. For example, the collection and delivery operations until the cargoes are delivered to the destination of shipment from the place of shipment are performed in such a manner that shippers take the cargoes to an agency such as a convenient store and the like and enter necessary items in shipment request slips of a duplication type and a physical distribution operator collets these cargoes with the slips and bring them into a collection/delivery center and the like, and the cargoes are assorted in the delivery center on the basis of the entered contents of the slips and are transferred to the cargo collection/delivery centers in the vicinity of the delivery destinations by a large-sized delivery van, and homes of the delivery destinations are confirmed and the delivery time zone is confirmed at the delivery destinations on the basis of the entered contents of the slips, and the cargoes are delivered by a small-sized delivery van.

In the recent physical distribution industry, due to utilization of the wide area network including computerization of the information necessary for the physical distribution and the Internet, high-speed and rationalization is being promoted. In these circumstances, due to time and spatial limits, institutional limits and limits on the part of the user, the slip transaction and the assorting operations of the cargoes to be collected and delivered have not been widely, effectively and rationally improved.

For example, though there is a service available for preparing (printing at a client side) the slip on a Web for the clients who can utilize the Internet and a computer, there has not been any, which widely and effectively speeds up and rationalizes a series of the physical distribution operations from the collection from the clients to the delivery to the delivery destinations.

An object of the present invention is to provide a cargo collection and delivery system capable of widely and effectively speeding up and rationalizing the slip transaction, the assorting operations and the like of the cargoes.

### SUMMARY OF THE INVENTION

In order to solve the above described problems, the present invention performs the control in a physical distribution operations from a cargo collection request to a delivery by giving and receiving slip information utilizing a radio communication network, a portable telephone network and Internet, so that the processing such as issuing of the slips at a cargo collection and delivery truck and a cargo agency, assorting operations in the cargo collection/delivery center, the cargo information control and the like are widely and effectively rationalized at high speed. Specifically, the invention aims to realize:

(a) reduction in the labor of a user accompanied with preparation of the slips at the shipment time, and reduction in the loss of time caused by the same operation of a delivery company/a cargo collection agency (such as a convenience store);

(b) automation and labor-saving of the physical distribution operations on the basis of a non-contact tag (RFID) for the cargo and the slip information;

(c) automation of collection instruction operations by driving control of cargo collection trucks interlocked with a GPS;

(d) automation of enquiry operations at the delivery time by driving control of the delivery trucks interlocked with the GPS and control of cargo loaded vehicles by the RFID;

(e) reduction of delivery during its absence by accurately instructing a delivery time zone for the enquiry of the delivery time;

(f) slip printing in print letters/printing on the cargo collection trucks; and

(g) writing the control information such as the slip numbers and the like in the RFID on the cargo collection trucks.

The invention is characterized in being constituted as follows:

(1) a cargo collection and delivery system in a physical distribution operation from collection of a cargo from a place of shipment to a destination of shipment, wherein

a control center is provided with means for issuing cargo slip information which can specify the cargo by a cargo unit which is requested for delivery upon receipt of a request for cargo collection from a client,

a cargo agency is provided with a slip issuing machine having a function of printing/printing in print letter for slip processing and of writing in a non-contact tag, whereby said cargo slip information is received from said control center and th3 information is printed or printed in print letter in the slip, and further, slip identification information which can straightly specify the slip information in the non-contact tag for the purpose of automation/labor-saving of the physical distribution operations is written and said slip and said non-contact tag are attached to the cargo carried in by the client,

a cargo collection truck for the cargo is provided with a portable terminal for slip processing, whereby said cargo slip information is received and the information is printed or printed in print letter in the slip, and further, slip identification information which can straightly specify the slip information in the non-contact tag for the purpose of automation/labor-saving of the physical distribution operations is written and said slip and said non-contact tag are attached to the cargo collected at client place,

a cargo collection/delivery center is provided with means,

whereby a cargo collection request is received from said control center, the slip processing of the cargo collected on the basis of a transfer/delivery destination code, and

warehousing-in/warehousing-out control and sorting operations are performed by transmission of the cargo collection instruction to said cargo collection truck, the slip identification information written in said non-contact tag at the cargo collection time and the slip information written in said non-contact tag at the cargo collection/delivery center and controlled by the control center, and

a cargo collection/delivery truck is mounted with a transmit-receive terminal for use of a GPS system and a remote navigation system which receives a traveling route prepared by said cargo collection/delivery center to display the route to a driver, and is controlled in traveling;

(2) the control center does a speech reception by a telephone and a reception via a Web Site of the Internet and mobile communication of a portable telephone for the reception of a cargo collection request from a client as a place of shipment of the cargo, and prepares slip information by the cargo unit of the delivery request, and when the cargo is carried to said cargo agency at the time of the reception issues the request number for the client, and

when the cargo is collected at the client place, a cargo collection instruction is transmitted to said cargo collection center which has jurisdiction over the client residential area after the reception is completed, and

when there is the slip information transmitting receiving request on the basis of the request number issued by the cargo agency at the reception time, it is transmitted to the cargo agency;

(3) the cargo agency is provided with means, whereby said slip information is received from said control center and the printing in print letter/printing said cargo slip and the writing of said slip identification information in the non-contact tag are performed at own office and completion of the cargo collection is informed to said control center;

(4) the cargo collection and delivery truck receives said slip information and the cargo collection instruction from said cargo collection/delivery center, and is provided with a remote navigation system prepared and updated by said cargo collection/delivery center from the position of said each cargo collection and delivery truck, the cargo collection/delivery place and the traffic information of the highway on the basis of the GPS system;

(5) the control center makes an enquiry about the delivery time to the delivery destination when the cargo is delivered and automatically gives a reply by a short time unit by using said traveling route information of said cargo collection and delivery truck which is controlled in said cargo collection/delivery center and the positional information transmitted by the cargo collection and delivery truck;

(6) the non-contact tag is an integral type pasted on an end portion of a slip and is formed in such a manner that said non-contact tag information is received from an antenna which is printed with a conductive resin in the entire peripheral area of the slip;

(7) in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it;

(8) in order to achieve the object such as a portability and a slip printing, the slip printing device mounted in said cargo collection and delivery truck uses a roll paper and performs the printing by a thermal transfer or a heat sensitive paper which secures a storage life, and in order to make it easy to cut off a deposit receipt or the like of the slip one by one, which is bound in several sheets, a perforated line is attached by a circular saw shaped cutter after each slip portion is printed; and

(9) remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.

### BRIEF DESCRIPTION OF THE DRAWINGS

FIG. 1 is a model schematic diagram of a cargo collection and delivery system showing embodiment of the present invention;

FIG. 2 is a processing form of a cargo collection operation in an embodiment;

FIG. 3 is a configuration diagram of a slip and a non-contact tag in the embodiment;

FIG. 4 is a configuration diagram of a dot printer for use of a blank form slip in the embodiment;

FIG. 5 is a configuration diagram of a dedicated slip print device in the embodiment;

FIG. 6 is a processing form of a physical distribution operation in the embodiment (No. 1);

FIG. 7 is a processing form of the physical distribution operation in the embodiment (No. 2);

FIG. 8 is a processing form of a cargo collection instruction operation in the embodiment;

FIG. 9 is a processing form of an enquiry operation of the delivery time in the embodiment (No. 1); and

FIG. 10 is a processing from of the enquiry operation of the delivery time in the embodiment (No. 2).

### DESCRIPTION OF THE PREFERRED EMBODIMENT

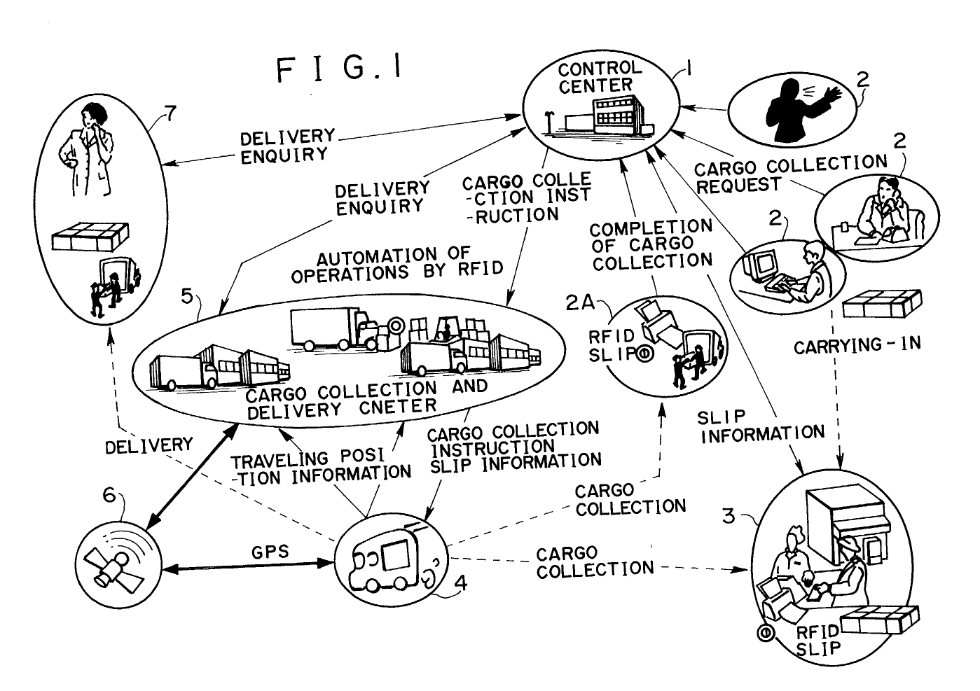

FIG. 1 is a model schematic diagram of a cargo collection and delivery system of the embodiment of the present invention.

A control center 1 is installed with a computer system and a communication system and performs a centralized control of entire physical distribution operation from collection of the cargoes to delivery. The control center 1 utilizes the existing public line (the telephone, the Internet and the like) and a GPS system as a communication system, and gives support to the cargo collection and delivery operations by communications among clients 2 and 2A, a cargo collection agency 3, a cargo collection and delivery truck 4, a cargo collection/delivery center 5 and a GPS system satellite 6, so that slip processing and assorting operations of the cargoes are widely and effectively rationalized at high speed.

The control center 1 does a speech reception by the telephone and the reception via a Web Site of the Internet and the mobile communication of a portable telephone for the reception of a cargo collection request from the client 2 as a place of shipment of the cargo, and prepares slip information which can specify the cargo by the cargo (one or plurality) unit of the delivery request. These slip information are collectively stored and controlled in a database of the control center 1.

This slip information contains addresses and names of the place of shipment and the delivery destination, the dimension and the weight of the cargo, the cargo collection, delivery time zone and the like, which are transmitted to the portable terminal provided in the computer for use of the operation processing of the control center 1 to the cargo agency 3 and the cargo collection/delivery center 5 and the cargo collection and delivery truck 4.

For example, when the client brings it to the cargo agency 3 during a delivery request reception time, a request number is issued for the client. When a cargo collection truck collects it at the client place, a cargo collection instruction is transmitted to the cargo collection/delivery center 5 which has jurisdiction over the client's living area after the reception of the delivery request is completed. When there is the slip information transmitting request on the basis of the request number issued by the cargo agency 3 at the reception time, it is transmitted to the cargo agency 3.

A number of cargo agencies 3 such as convenient stores and the like have communication facilities with the control center 1 and print or perform printing in print letter the slip information received from the control center by radio reception. For the purpose of automation/labor-saving of the physical distribution operations, a slip issuing machine having a print/printing function and a RFID (non-contact tag) writing function is provided, whereby the slip identification information which can straightly specify the slip information in a RFID made of an IC chip is written in an internal memory, and the slip and the RFID are attached to the cargo bought by the client so as to perform the slip processing.

This issuing machine has a function, wherein, when the client 2 requests for the collection of the cargo, the machine receives the slip information from the control center 1 and when printing in print letter or printing of it on the cargo slip and writing the slip identification information on the RFID is performed, it automatically transmits the completion of the collection of the cargo to the control center 1.

Note that the cargo agency 3 can allow the machine to have a function to issue the slip and the RFID at its own office as the additional function of the issuing machine. In this case, by the cargo agency 3 just notifying the control center 1 of acquisition of the issue number (slip number) when the slip is issued using such that can accommodate, the conventional reception method, where the cargo is directly carried in without informing the control center 1, the slip information can be effectively utilized for the subsequent cargo collection and delivery operations.

Next, a number of cargo collection and delivery trucks 4 are installed with portable terminals which, similarly to the above descried slip issuing machine, realize a function of writing the slip identification information in the RFID through reception of the slip information and printing it as the cargo slip by a software and a compact printer which are mounted on the terminals. Further, the delivery made through a plurality of cargo collection/delivery centers contains its route information, which is written in the RFID and printed also in the slip.

When each cargo collection and delivery truck 4 installed with such a portable terminal receives the cargo collection instruction and the slip information from the control center 1 via the cargo collection/delivery center 5, the truck performs issuing of the RFID and print/printing of the cargo slip whereby it proceeds to the cargo location of the client 2A and collects the cargo and gives a copy of the cargo slip to the client 2A, and at the same time, attaches the RFID and the cargo slip to the cargo and automatically transmits collection completion information of the cargo to the control center 1. Further, each cargo collection and delivery truck 4 proceeds to the cargo agency 3 and collects the cargoes collected by the agency 3. These cargoes collected are collected at the cargo collection/delivery center 5 and further are directly delivered to the delivery destinations. Note that the RFID is sometimes in formation that is integral with the printing slip.

The cargo collection instruction from the control center 1 to the cargo collection and delivery truck 4 is given to slip information processor by communications, which is constituted by the computer having a communication function and installed in the cargo collection/delivery center 5. One of the instruction methods is such that the cargo collection instruction is given to the cargo collection/delivery center 5 from the control center 1 by the transmission of the slip information, and a route is provided for directly instructing the cargo collection and delivery truck 4 from the cargo collection/delivery center 5 by using the slip information processor.

The other instruction method is such that a remote navigation system, which is prepared/updated by the cargo collection/delivery center from the current positional information and the cargo collection/delivery place of the cargo collection and delivery truck and the traffic information of the highway, is provided by utilizing the GPS system and a route is provided for instructing these pieces of the information to the cargo collection and delivery truck 4 in the location closest to the client by sending and receiving them to and from the terminal equipment of the cargo collection and delivery truck 4.

Upon receipt of the cargo collection request from the control center 1, the cargo collection/delivery center 5 transmits the cargo collection instruction to the cargo collection truck 4, and performs the slip processing of the cargo collected on the basis of a transfer/delivery destination code from the slip identification information written in the non-contact tag at the cargo collection time and the slip information written in the non-contact tag at the cargo collection/delivery center and controlled in the control center as well as a warehousing-in/warehousing-out control and assorting operations.

Note that, when the cargo is delivered, the control center 1 has a function of making an enquiry to the delivery destination about the delivery time and automatically giving a reply within a short time unit by using the traveling route information of the cargo collection and delivery truck which is controlled by the cargo collection/delivery center 5 and positional information which is transmitted from the cargo collection and delivery truck.

In the cargo collection and delivery system constituted as above, the operations from the cargo collection request from the client to the cargo collection and the delivery are supported by the issuing of the slip information by the control center 1, the issuing machine of the slip and the RFID installed in the cargo agency or the cargo collection/delivery center 5, the communications by the portable terminal provided in the cargo collection and delivery truck 4, the slip print in print letter/printing and the issuing of the RFID.

For example, the cargo agency 3 merely attaches the slip and the RFID, which are issued on the basis of the received slip information, to the cargo carried in and can simply perform a receipt processing without losing time. Further, when the cargo is collected by the cargo collection and delivery truck 4, the slip and the RFID can be attached to the cargo by printing in print letter the slip and writing the RFID on the cargo collection truck so that the cargo collection operation can be performed without losing time.

Further, by obtaining the information from the slip and the RFID attached to the collected cargoes, the cargo collection and delivery truck 4 and the cargo collection/delivery center 5 can realize automation of physical distribution operations after the cargoes are collected (warehousing-in control, assorting process, warehousing-out control), accounting operations (the number of cargoes handled, etc), and business operations (client control, various utilization statistics, etc).

Further, by utilizing the GPS system, traveling position control of the cargo collection and delivery/key point transportation truck, automation of the telephone enquiry about the delivery on the basis of the control of the cargo loaded truck by the slip information and giving a reply on the delivery time by a short time zone unit can be realized.

Further, automatic renewal of the cargo situation (collection of the cargo, key point transportation, delivery and the like) in the enquiry about the cargo situation by using the Internet and the mobile function of the portable telephone and supply of the detailed information regarding the cargo position can be realized.

Note that the address information of the clients (the places of shipment, the destinations of shipment) shall be prepared and controlled by the system side by the following method. For example, in the case of the collection request by utilizing the Web site, the clients who have the collection requests do the input the collection request via the Web site. In the case of a hand-written slip, the shippers of the cargoes put a mark in a column of an address control request intention confirmation set on a predetermined position on the slip, and then, the cargo collection/delivery center 5 inputs each address information of the places of shipment and the destinations of shipment.

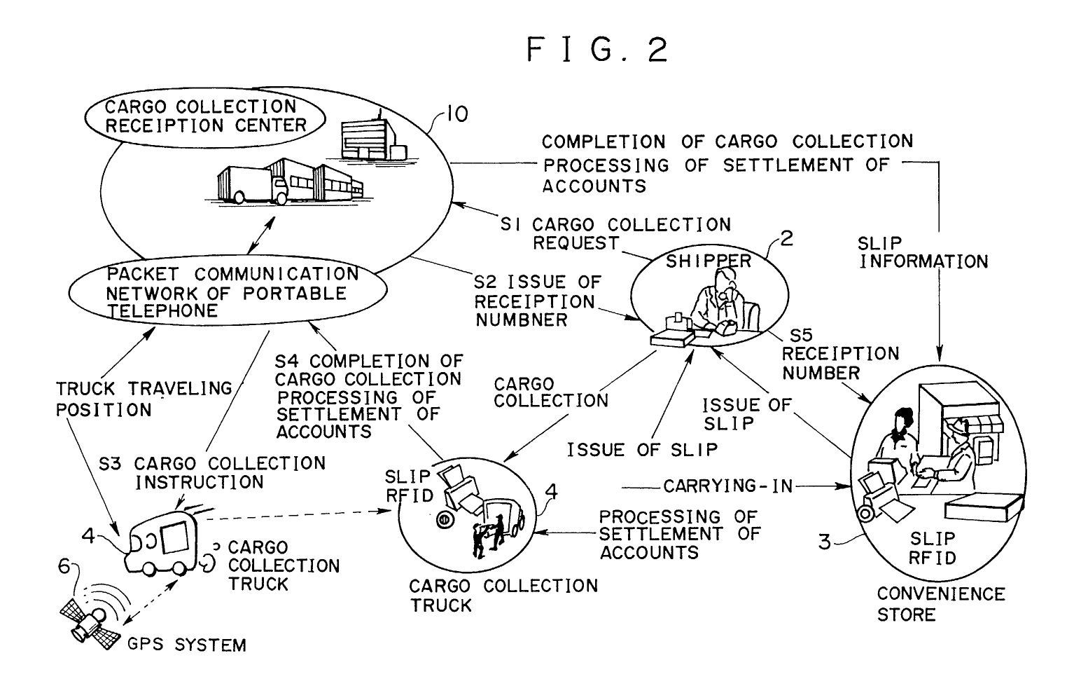

Hereinafter, the details of each operation processing will be described with reference to FIGS. 2 to 10.

(1) Automation of Cargo Collection Operation (FIG. 2)

In the cargo collection request (S1), when the client control is already enforced, it is enough to inform a cargo collection receipt center 10 (means the control center 1 and the cargo collection/delivery center 5) of the telephone number of the client and the telephone number of the delivery destination and the like (the cargo collection/delivery place, a payment of transportation charge, a mode of payment, a type of the cargo) according to the automatic reply of the telephone. In the case of the shipper and the delivery destination which are not registered, the registration operation (full name, telephone number, address and the like) is carried out and confirmed by the Internet and the Web site of the portable telephone, and then, cargo collection request is performed.

In the receipt confirmation (S2), after the cargo collection receipt center 10 receives the cargo collection request, the receipt number is issued for the client.

In the cargo collection instruction (S3), when the cargo collection place is not a predetermined route collection place (such as the convenience store and the business office) but at one's own house, the cargo collection information (cargo collection place, full name, telephone number and the like) is transmitted to the portable terminal mounted on the nearest cargo collection truck under the control of the traveling area by the communications which utilize the GPS system.

In the cargo collection (S4), the cargo collection processing is performed at the cargo collection place on the basis of the above described cargo collection information. This processing involves transmission of the transportation charge to the cargo receipt center 10, reception of the final slip, printing on the blank form slip and execution of a predetermined cargo collection procedure. Further, settlement of accounts is conducted as specified at the time of the cargo collection request.

In the cargo bringing in processing (S5), when a route cargo collection place (convenience store and the like) is designated at the cargo collection request time, the client brings the cargo to the designated cargo collection place and informs a receipt number issued at the request time to a person in charge so that a predetermined receipt processing is performed.

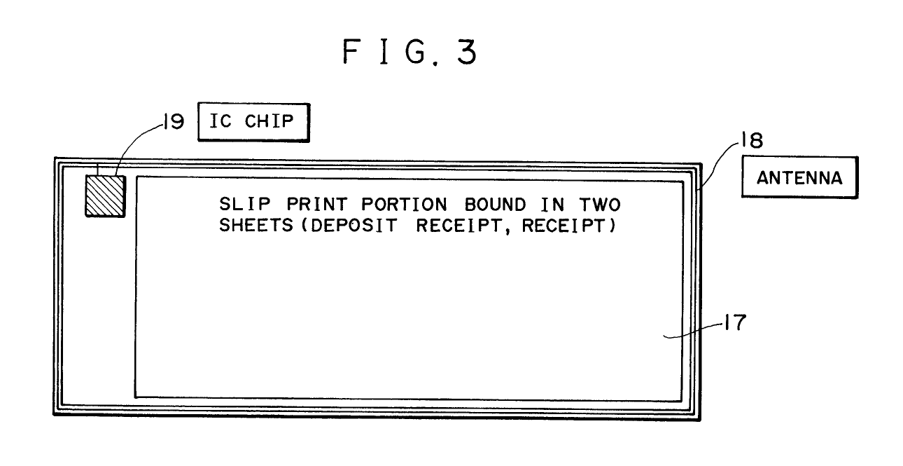

(2) Issuing of the Slip (FIG. 3)

The cargo collection processing is, basically as in the past, performed by attaching the issued slip to the cargo and giving a deposit receipt to the shipper. This slip is also attached with a RFID 19 in which the issued slip number is written by a dedicated terminal provided in the truck or the route cargo collection place. This slip is such that sensitivity and a slip are linked with each other (which is bound in about two sheets reduced from the current six sheets and the remaining sheets are replaced by the RFID). In this case, as shown in the drawing, the slip is constituted in such a manner that it has a size enough to print in print letter the usual slip information and constitutes an antenna 18 which uses a conductive material such as carbon for its outer periphery, so that transmission radio wave from the control center 1 and the like is picked up by the antenna 18 and the slip information is received at a chip 19 and is given to the slip print device at the same time.

According to this constitution, the RFID and the slip are integrally formed, and its handling and control become simple. Further, when the delivery of the cargo is completed, the RFID is removed from the slip and carried back so that it can be recycled for a new slip.

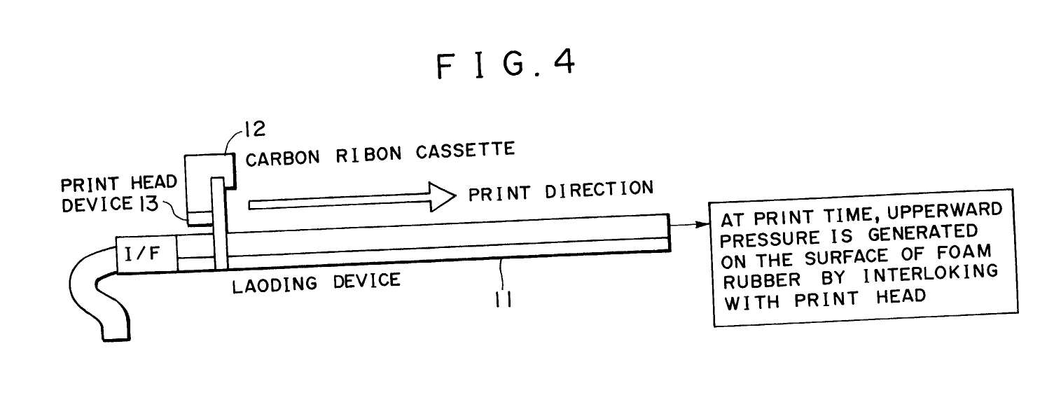

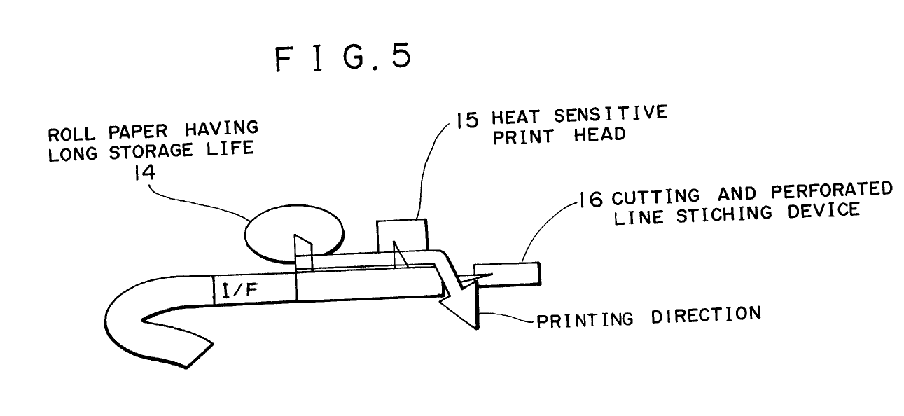

(3) Slip Print Device (FIGS. 4, 5)

The printer for issuing the slip, similar to the existing one for use of the cargo slip, is bound in six to seven sheets so that at every operation in delivery destination, the cargo agency, the cargo collection/delivery center, the cargo collection truck and the like each can be obtained as a control slip. The printer for this purpose is, as shown in FIG. 4, constituted in such a manner that a blank form slip is placed on the surface of a foam rubber of a loading device 11, and a print head 13 having a carbon ribbon cassette 12 is allowed to travel on this slip in the printing direction.

Note that, in order to make it possible to print in print letter on the current slip which is given a portability and bound in six sheets, a slip printing device mounted in the collection and delivery truck is preferably constituted in such a manner as to allow the impact of printing and the print to interlock with each other so as to push a print base upward, which is coated with an elastic material having a resistance to slip, thereby reinforcing it.

Next, the printer shown in FIG. 5 leads out the roll paper of a thermal transfer or heat sensitive type having a long storage life on the printing surface as the slip paper, and a heat sensitive print head 15 is printed out a deposit receipt, a cargo label and the like on the basis of the received slip information, which are cut and stitched by a cutting/perforated line stitching device 16. This device 16 attaches a perforated line by a circular saw shaped cutter after the slip portion is printed in order to make it easy to cut off a deposit receipt or the like of the slip one by one.

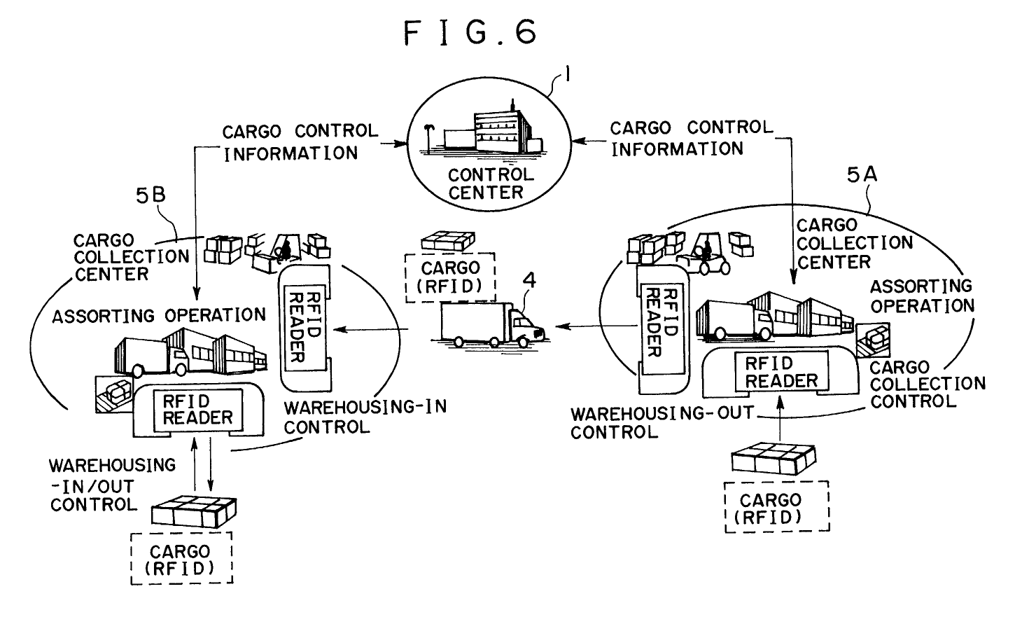

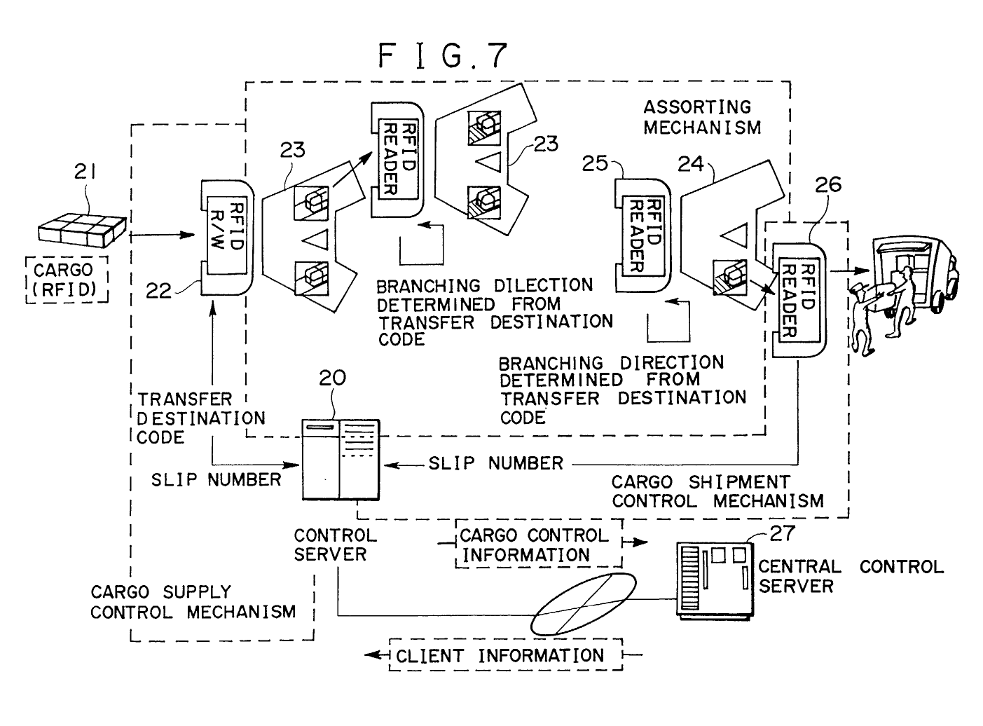

(4) Automation and Labor-Saving of Physical Distribution (FIGS. 6 and 7)

In FIG. 6, after the cargo was collected in the above described cargo collection operation (1), a cargo collection center 5A writes the cargo collection slip code in the RFID by using the dedicated portable terminal and attaches it to the cargo together with the slip, thereby performing the cargo collection control. For this control, a RFID reader is used, which reads the delivery destination from the RFID to be used for the assorting operations, and further, performs a warehousing-out control. In addition, it automates a sale control and the like by giving/receiving the cargo collection control information to/from the control center 1.

A delivery center 5B reads the cargo information from the RFID by using the RFID reader with respect to the cargo carried in from the cargo collection center 5A to perform a warehousing-in control. Further, the cargo information is utilized for the warehousing-out control by conducting the assorting operations. In addition, the reader automates a sale control and the like by giving/receiving the cargo collection control information to/from the control center 1.

FIG. 7 shows a control form of the cargo collection/delivery center and takes a control server 20 as an information processor for the warehousing-in/out. The slip number is read from the RFID attached to a warehoused-in cargo 21 by a RFID reader/writer 22 and is transmitted to the control server 20, and the control server 20 returns a transfer destination code read on the basis of the slip number to the RFID reader/writer 22, whereby the transfer destination code is written in the RFID of the cargo and is transferred to a RFID reader 25 of the target assorting mechanism 24 by a plurality of conveying equipment 23 such as belt conveyers inside the center by branching control of the transfer direction which is the target destination, and the warehousing-out and the control information (slip number) are transmitted to the control server 20 by reading the RFID by a reader 26 of the assorting mechanism 24. The control server 20 gives/receives the control information from the warehousing-in to the warehousing-out of the cargo to/from a central control server 27 of the control center 1.

In this way, the RFID is utilized as the cargo slip number so that a minute and labor-saving cargo control can be realized in contrast to the conventional system (intervened by ones' hands) using the bar code.

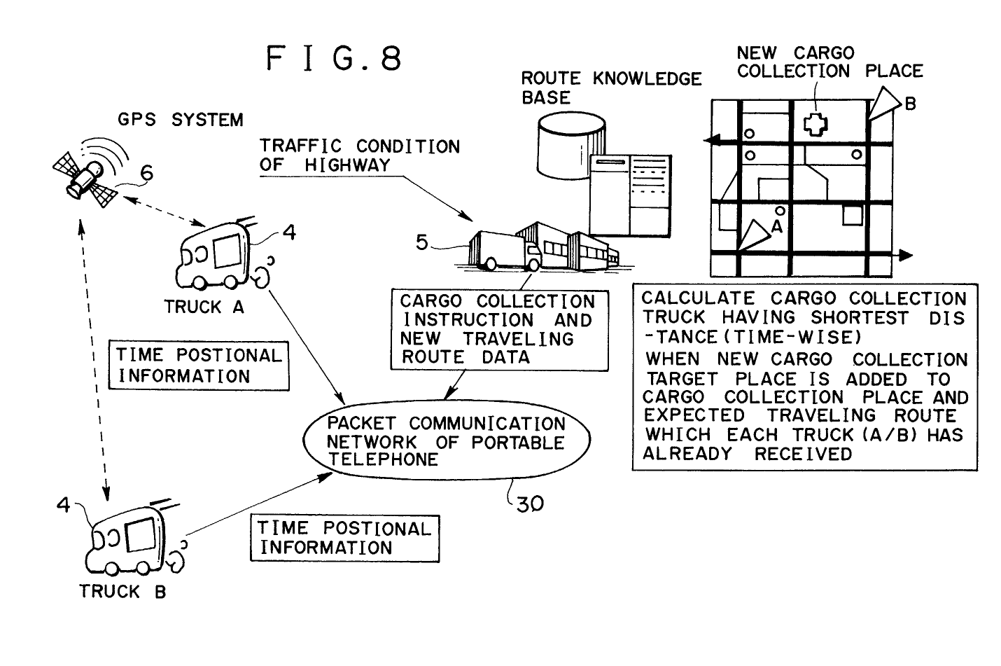

(5) Automation of Cargo Collection Instruction Operation and Remote Control of Traveling Route (FIG. 8)

As described above, the cargo collection/delivery truck receives a traveling route which is prepared by the GPS system and the cargo collection center, mounts a transmit-receive terminal for use of the remote navigation which is displayed to a driver and is controlled in the traveling, so that the automation of the cargo collection instruction operation and the remote control of the traveling route are made possible.

The control form shown in FIG. 8 constructs the remote navigation system by a truck position control center 30, the cargo collection/delivery center 5, a GPS receiver mounted on the cargo collection and delivery truck and a GPS 6.

For this reason, the cargo collection/delivery center 5 is provided with means for determining the most suitable (the most shortest distance) truck for the cargo collection from the positional information of each cargo collection and delivery truck, map information and the traffic condition of the highway as well as a route knowledge to infer the most suitable traveling route for the truck and an inferring system.

Each truck 4 is mounted with the receiver of the GPS system and mounted with a navigator capable of obtaining own geographical positional information and displaying it inside the truck, and is provided with a function of periodically transmitting the positional information received by this navigator together with time information to the truck position control center 30.

In this way, when the cargo collection/delivery center 5 receives the cargo collection instruction from the control center 1, it transmits the cargo collection instruction to the truck position control center 30, and on the basis of this cargo collection instruction, the truck position control center 30 returns the current truck position information to the cargo collection/delivery center 5. The cargo collection/delivery center 5 determines the most suitable truck and the traveling route (the most suitable TSP) for the cargo collection, which is transmitted to the truck 4 via the truck position control center 30, and the truck 4 can proceed to the cargo collection by utilizing the navigator.

In this way, the difference of operational achievement between skilled drivers and unskilled drivers can be reduced, and at the same time, effective employment of the cargo collection and delivery trucks is made possible.

Note that it is preferable that, when the possible route is prepared at the time of the TSP processing, a limited condition is imposed in such a manner that the traveling route is prepared in order of the cargo collection request by adding the elapsed time from the receipt of the cargo collection request at each cargo collection place (traveling place) as a weight. For the actual calculation, since an amount of calculation increases exponent function wise depending on the number of cargo collection and delivery trucks and the number of cargo collection places per one truck, it is preferable that the calculation gives a reply (collect) on the basis of a first value which satisfies a predetermined object value (threshold), thereby optimizing the processing (accommodating) time for each case.

Further, the information content and the information processing method in the above described remote navigation system calculates the traveling route of each collection and delivery truck as a limited traveling salesman problem due to the cargo collection/delivery time designation as an optimum approximate solution by using the traveling positional information of the collection destination and the delivery destination, the positional information along the time sequence which is transmitted from each collection and delivery truck mounted with the GPS system, the traveling situation such as running speed of each cargo collection truck obtained from the same information, and the traffic information of the area on the basis of an external traffic information distribution system such as ITS and the like, and when the traveling place on the basis of the truck departure time, the cargo collection request and the delivery time designation and the like is added and the traveling sequence is changed, it is preferable that calculation is made so that the traveling route is transmitted to the cargo collection truck during cargo collection and delivery.

(6) Automation of Enquiry Operation at Delivery Time (FIGS, 9 and 10)

By utilizing the above described remote navigation system, automatic reply of the short time unit (one hour, thirty minutes and the like) for the delivery enquiry from the client is made possible from position/status control information of the cargo on the basis of the RFID attached to the cargo and position/route control information of the cargo collection and delivery truck which loads the cargo.

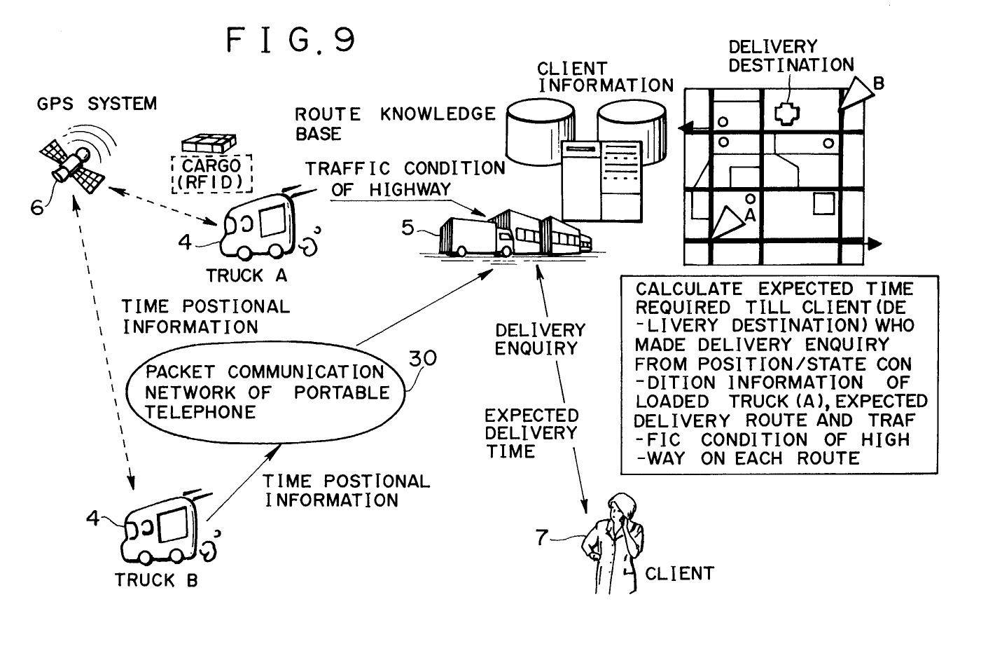

In FIG. 9, when the enquiry about a delivery schedule from a shipper 7 of the cargo is made to the cargo collection/delivery center 5 or the control center 1, the cargo collection/delivery center 5 recognizes the truck which loads the cargo from the slip number of the RFID, recognizes its position and estimates a delivery possible time and informs the client.

Note that the delivery enquiry is preferably made possible not only by the slip number, but also by the telephone number of the delivery destination. In the case of the enquiry by the telephone number of the delivery destination, an estimated delivery time of the cargo (already arrived at the cargo collection/delivery center/the cargo collection/delivery office) reliably deliverable on the date the enquiry was made is informed.

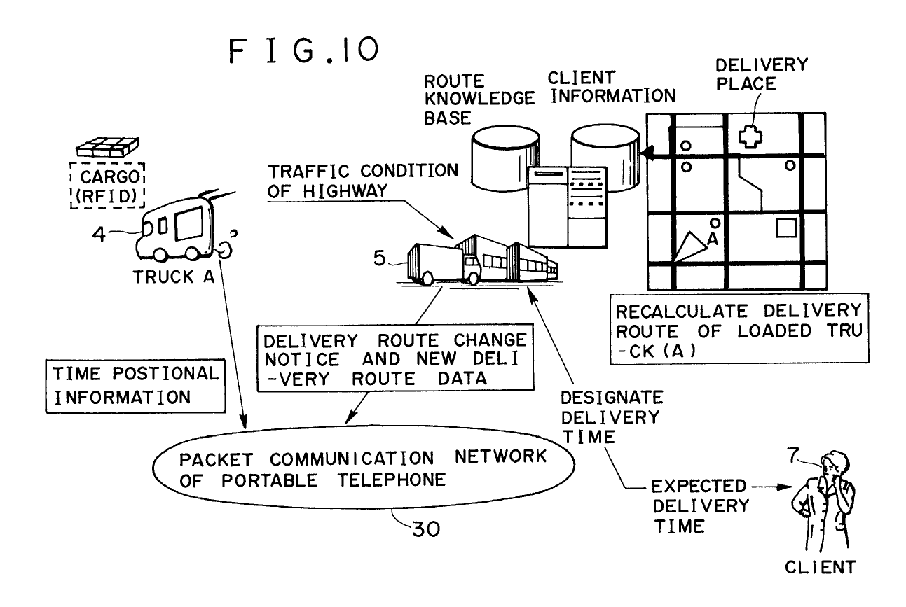

Further, change/designation of the delivery time can be automatically responded within a possible range (possible range of reconstructing the delivery route). This form is shown in FIG. 10. When an enquiry is made from a client 7, similar to the above described cargo collection route control (5), the traveling route is changed and one that is the nearest to the designated time of the delivery place (designated and expected time replied upon delivery enquiry) is taken as the most suitable delivery route, and a change notice of the delivery route and new route information are transmitted to the cargo delivery truck.

As described above, according to the present invention, the control in the physical distribution operations from the collection request of the cargo to the delivery is performed by giving and receiving the slip information by utilizing a radio communication network, a portable telephone network and the Internet so that the processing of issuing the slip and the like by the cargo collection and delivery truck and the cargo agency, the assorting operations in the cargo collection/delivery center, the cargo information control and the like can be widely and effectively rationalized at high speed.

What is claimed is:

1. A cargo collection and delivery system in a physical distribution operation from collection of a cargo from a place of shipment to a destination of shipment, wherein
a control center is provided with means for issuing cargo slip information which can specify the cargo by a cargo unit which is requested for delivery upon receipt of a request for cargo collection from a client,
a cargo agency is provided with a slip issuing machine having a function of printing/printing in print letter for slip processing and of writing in a non-contact tag, whereby said cargo slip information is received from said control center and the information is printed or printed in print letter in the slip, and further, slip identification information which can straightly specify the slip information in the non-contact tag for the purpose of automation/labor-saving of the physical distribution operations is written and said slip and said non-contact tag are attached to the cargo carried in by the client,
a cargo collection truck for the cargo is provided with a portable terminal for slip processing, whereby said cargo slip information is received and the information is printed or printed in print letter in the slip, and further, slip identification information which can straightly specify the slip information in the non-contact tag for the purpose of automation/labor-saving of the physical distribution operations is written and said slip and said non-contact tag are attached to the cargo collected at client place,
a cargo collection/delivery center is provided with means,
whereby a cargo collection request is received from said control center, the slip processing of the cargo collected on the basis of a transfer/delivery destination code, and
warehousing-in/warehousing-out control and sorting operations are performed by transmission of the cargo collection instruction to said cargo collection truck, the slip identification information written in said non-contact tag at the cargo collection time and the slip information written in said non-contact tag at the cargo collection/delivery center and controlled by the control center, and
a cargo collection/delivery truck is mounted with a transmit-receive terminal for use of a GPS system and a remote navigation system which receives a traveling route prepared by said cargo collection/delivery center to display the route to a driver, and is controlled in traveling.

2. The cargo collection and delivery system according to claim 1, wherein said control center does a speech reception by a telephone and a reception via a Web Site of the Internet and mobile communication of a portable telephone for the reception of a cargo collection request from a client as a place of shipment of the cargo, and prepares slip information by the cargo unit of the delivery request, and when the cargo is carried to said cargo agency at the time of the reception issues the request number for the client, and
when the cargo is collected at the client place, a cargo collection instruction is transmitted to said cargo collection center which has jurisdiction over the client residential area after the reception is completed, and
when there is the slip information transmitting receiving request on the basis of the request number issued by the cargo agency at the reception time, it is transmitted to the cargo agency.

3. The cargo collection and delivery system according to claim 1 or 2, wherein said cargo agency is provided with means, whereby said slip information is received from said control center and the printing in print letter/printing said cargo slip and the writing of said slip identification information in the non-contact tag are performed at own office and completion of the cargo collection is informed to said control center.

4. The cargo collection and delivery system according to claim 1 or 2, wherein a cargo collection and delivery truck receives said slip information and the cargo collection instruction from said cargo collection/delivery center, and is provided with a remote navigation system prepared and updated by said cargo collection/delivery center from the position of said each cargo collection and delivery truck, the cargo collection/delivery place and the traffic information of the highway on the basis of the GPS system.

5. The cargo collection and delivery system according to claim 3, wherein a cargo collection and delivery truck receives said slip information and the cargo collection instruction from said cargo collection/delivery center, and is provided with a remote navigation system prepared and updated by said cargo collection/delivery center from the position of said each cargo collection and delivery truck, the cargo collection/delivery place and the traffic information of the highway on the basis of the GPS system.

6. The cargo collection and delivery system according to any one of claims 1, 2 and 5, wherein said control center makes an enquiry about the delivery time to the delivery destination when the cargo is delivered and automatically gives a reply by a short time unit by using said traveling route information of said cargo collection and delivery truck which is controlled in said cargo collection/delivery center and the positional information transmitted by the cargo collection and delivery truck.

7. The cargo collection and delivery system according to claim 3, wherein said control center makes an enquiry about the delivery time to the delivery destination when the cargo is delivered and automatically gives a reply by a short time unit by using said traveling route information of said cargo collection and delivery truck which is controlled in said cargo collection/delivery center and the positional information transmitted by the cargo collection and delivery truck.

8. The cargo collection and delivery system according to claim 4, wherein said control center makes an enquiry about the delivery time to the delivery destination when the cargo is delivered and automatically gives a reply by a short time unit by using said traveling route information of said cargo collection and delivery truck which is controlled in said cargo collection/delivery center and the positional information transmitted by the cargo collection and delivery truck.

9. The cargo collection and delivery system according to any one of claims 1, 2, 5, 7 and 8, wherein said non-contact tag is an integral type pasted on an end portion of a slip and is formed in such a manner that said non-contact tag information is received from an antenna which is printed with a conductive resin in the entire peripheral area of the slip.

10. The cargo collection and delivery system according to claim 3, wherein said non-contact tag is an integral type pasted on an end portion of a slip and is formed in such a manner that said non-contact tag information is received from an antenna which is printed with a conductive resin in the entire peripheral area of the slip.

11. The cargo collection and delivery system according to claim 4, wherein said non-contact tag is an integral type pasted on an end portion of a slip and is formed in such a manner that said non-contact tag information is received from an antenna which is printed with a conductive resin in the entire peripheral area of the slip.

12. The cargo collection and delivery system according to claim 6, wherein said non-contact tag is an integral type pasted on an end portion of a slip and is formed in such a manner that said non-contact tag information is received from an antenna which is printed with a conductive resin in the entire peripheral area of the slip.

13. The cargo collection and delivery system according to any one of claims 1, 2, 5, 7, 8 and 10 to 12, wherein, in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it.

14. The cargo collection and delivery system according to claim 3, wherein, in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it.

15. The cargo collection and delivery system according to claim 4, wherein, in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it.

16. The cargo collection and delivery system according to claim 6, wherein, in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it.

17. The cargo collection and delivery system according to claim 9, wherein, in order to make it possible to print on the current slip which is given a portability and bound in six sheets, a slip printing device mounted in the said cargo collection and delivery truck allows the impact of printing and the print to interlock with each other so as to push a print base upward, which is coated with an elastic material having a resistance to slip, thereby reinforcing it.

18. The cargo collection and delivery system according to any one of claims 1, 2, 5, 7, 8 and 10 to 12, wherein, in order to achieve the object such as a portability and a slip printing, the slip printing device mounted in said cargo collection and delivery truck uses a roll paper and performs the printing by a thermal transfer or a heat sensitive paper which secures a storage life, and in order to make it easy to cut off a deposit receipt or the like of the slip one by one, which is bound in several sheets, a perforated line is attached by a circular saw shaped cutter after each slip portion is printed.

19. The cargo collection and delivery system according to claim 3, wherein, in order to achieve the object such as a portability and a slip printing, the slip printing device mounted in said cargo collection and delivery truck uses a roll paper and performs the printing by a thermal transfer or a heat sensitive paper which secures a storage, life and in order to make it easy to cut off a deposit receipt or the like of the slip one by one, which is bound in several sheets, a perforated line is attached by a circular saw shaped cutter after each slip portion is printed.

20. The cargo collection and delivery system according to claim 4, wherein, in order to achieve the object such as a portability and a slip printing, the slip printing device mounted in said cargo collection and delivery truck uses a roll paper and performs the printing by a thermal transfer or a heat sensitive paper which secures a storage life, and in order to make it easy to cut off a deposit receipt or the like of the slip one by one, which is bound in several sheets, a perforated line is attached by a circular saw shaped cutter after each slip portion is printed.

21. The cargo collection and delivery system according to claim 6, wherein, in order to achieve the object such as a portability and a slip printing, the slip printing device mounted in said cargo collection and delivery truck uses a roll paper and performs the printing by a thermal transfer or a heat sensitive paper which secures a storage life, and in order to make it easy to cut off a deposit receipt or the like of the slip one by one, which is bound in several sheets, a perforated line is attached by a circular saw shaped cutter after each slip portion is printed.

22. The cargo collection and delivery system according to claim 9, wherein, in order to achieve the object such as a portability and a slip printing, the slip printing device mounted in said cargo collection and delivery truck uses a roll paper and performs the printing by a thermal transfer or a heat sensitive paper which secures a storage life, and in order to make it easy to cut off a deposit receipt or the like of the slip one by one, which is bound in several sheets, a perforated line is attached by a circular saw shaped cutter after each slip portion is printed.

23. The cargo collection and delivery system according to any one of claims 1, 2, 5, 7, 8 and 10 to 12, wherein said remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.

24. The cargo collection and delivery system according to claim 3, wherein said remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.

25. The cargo collection and delivery system according to claim 4, wherein said remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.

26. The cargo collection and delivery system according to claim 6, wherein said remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.

27. The cargo collection and delivery system according to claim 9, wherein said remote navigation system calculates the traveling route of each cargo collection and delivery truck as a limited traveling salesman problem due to the cargo collection/delivery time designation as an optimum approximate solution by using map information, traveling positional information of a collection destination and a delivery destination, positional information along a time sequence which is transmitted from each cargo collection and delivery truck mounted with the GPS system, a traveling situation such as the running speed of each cargo collection and delivery truck obtained from the same information and traffic information of the area on the basis of an external traffic information distribution system such as ITS and the like, and when the traveling location based on the departure time, the cargo collection request, the delivery time designation and the like is added and the traveling sequence is changed, said calculation is made so that the traveling route is transmitted to said cargo collection and delivery truck during cargo collection and delivery.
